(19) United States
(12) Patent Application Publication
(10) Pub. No.: US 2010/0042535 A1
(43) Pub. Date: Feb. 18, 2010

(54) CURRENCY DISPLAY

(75) Inventor: Carl B. Stone, Campbell, CA (US)

Correspondence Address: Haynes and Boone, LLP;IP Section, 2323 Victory Avenue, SUITE 700, Dallas, TX, 75219, US

(73) Assignee: eBay Inc., San Jose, CA (US)

(21) Appl. No.: 12/192,479

(22) Filed: Aug. 15, 2008

(51) Int. Cl. G06Q 40/00; G06Q 10/00

(52) U.S. Cl. 705/39; 705/1

(57) ABSTRACT

Actual currency is shown displayed on a user device, where the currency represents an amount of money selected by the user. For example, if the user selects $86.21 for U.S. Dollars, the display will show four twenty dollar bills, one five dollar bill, one one dollar bill, two dimes, and one penny.

### BACKGROUND

1. Field of Invention

The present invention relates to electronic visual displays, and in particular, to such displays that show a visual representation of financial instruments.

2. Related Art

With the expansion of Internet commerce, consumers can easily and readily purchase items and services throughout the world. Consumers locate or identify a desired item or service on the Internet, such as with a PC, laptop, PDA, mobile phone, or other suitable device. The consumer can then make the purchase by entering the amount of money to be transferred to the seller. The consumer may be given the option of confirming the amount or the purchase. The consumer typically clicks on an icon or button to make the transfer. So, for example, if a transaction is between parties in the United States and Russia, the consumer in the United States may enter $126.32, which transfers $126.32 in U.S. dollars from the consumer's funding source (e.g., bank or credit card) and deposits the equivalent (2926.05 rubles) in Russian Rubles (RUR) to the seller's account in Russia.

Consumers may also bid on items on-line, where such bids do not represent a completed transaction, but simply a promise to pay that amount if the bid is the high bid. In such situations, such as bidding on eBay, the consumer again simply types in an amount he wants to bid. Once the consumer confirms the bid, which may include a new screen showing the entered amount with a “confirm” button, that amount is relayed to the seller as an amount the consumer is willing to pay for the goods or service. If the bid is accepted by the seller or is the high bid, the consumer's funds are transferred to the seller's account.

### SUMMARY

According to one aspect of the present invention, a user types in an amount and selects a type of currency. The user's device, such as a mobile phone, displays the actual currency representing the entered amount on background of the display or screen. For example, if the user types in $22.86 and selects USD, the screen shows a twenty dollar bill, two one dollar bills, three quarters, one dime, and one penny. The user device may also enable a different currency to be displayed, i.e., currency conversion. In this embodiment, a user may want to see the currency in South Korean won equivalent to $22.86 USD, such as for bartering. The user may select a different currency or a currency conversion at any time.

The display foreground can include recipient name, amount, funding source, shipping address, etc. Once the money is sent, such as by a tap, currency disappears, fades, moves out of screen, stays visible, or any other suitable graphic. The display may also show a user's specific card used to send funds, such as a PayPal card, Visa, MC, AMEX, etc. The visual image of the card can be shown in the background and relevant information, such as balance, past transactions, current transaction, amount, etc., can be shown on the foreground. In other embodiments, the user may select or create his own currency for display, such as casino chips, gold bars, personalized currency with the user's photo, etc. In another embodiment, the user can slide or swipe money to visual representations of other people on the screen or table to effect a money transfer.

In another embodiment, the recipient device has the same or similar graphics that show when funds are transferred to the recipient's account by displaying actual currency. The actual currency can be based on the sender's account, the recipient's account, or the recipient's selection, either real currency or personalized non-legal currency. The recipient may also have the option of selecting a specific account for the funds to be deposited, such as a bank account, credit card, or money market.

This invention will be more fully understood in light of the following detailed description taken together with the accompanying drawings.

### BRIEF DESCRIPTION OF THE DRAWINGS

FIG. 1 shows a currency display on a user device according to one embodiment of the present invention;

FIG. 2 shows a currency display on a user device according to another embodiment of the present invention;

FIG. 3 is a flowchart showing steps for using one embodiment;

FIG. 4 is a block diagram of a system for using one embodiment of the present invention; and

FIG. 5 is a block diagram of a system for implementing a device according to one embodiment of the invention.

It should be appreciated that like reference numerals are used to identify like elements illustrated in one or more of the figures.

### DETAILED DESCRIPTION

Embodiments of the present disclosure enable users to see a selected actual currency representing the amount entered by the user into a device with a display screen. For example, if the user enters $33.26 in U.S. dollars, the display will show one U.S. twenty dollar bill, one U.S. ten dollar bill, three U.S. one dollar bills, one U.S. quarter, and one U.S. penny. This gives the user a visual representation of the amount, which reinforces the value of the amount and provides the user with a more visually rich interface.

In one embodiment, the user device, such as a mobile phone or laptop, is in communication with another device through a network, such as the Internet or other wireless network. When the currency representation is shown, the user can send the entered amount to another user through the network. Visually, this can be shown as the currency sliding or moving off the display, just disappearing, or any other movement of the currency.

The display can show the user currency or the currency of another country. For example, if the user is working with U.S. dollars (the user's funds are located in U.S. banks) but wants to see the equivalent in Russian rubles, the user can enter $126.32 in U.S. dollars, but the display will show 2926.05 RUB in actual rubles. This enables a user to show a foreign merchant or retailer the amount he is willing to spend to purchase an item, which could greatly help in bargaining.

In other embodiments, the user can select the type of currency for display. It can be actual legal currency (e.g., U.S. dollars, Euros, Russian rubles, Japanese yen, etc.) or it can be a non-legal “currency”, such as poker or casino chips, gold bars, or even currency created by the user, such as bills with the user's face or other selected image. In still other embodiment, an image of a specific financial instrument, such as an American Express Card Platinum card, a Wells Fargo bank card, etc., is displayed when entered by the user. Actual currency and/or dollar amount may also be displayed on the same screen.

When the user is connected to a network with other users, the user display may visually show other users. In this embodiment, once the actual currency is shown, the user may simply drag the currency to the other user's icon to transfer the funds to the other user.

Therefore, it should be appreciated that various embodiments of the present disclosure may extend beyond simply presenting a visual representation of currency.

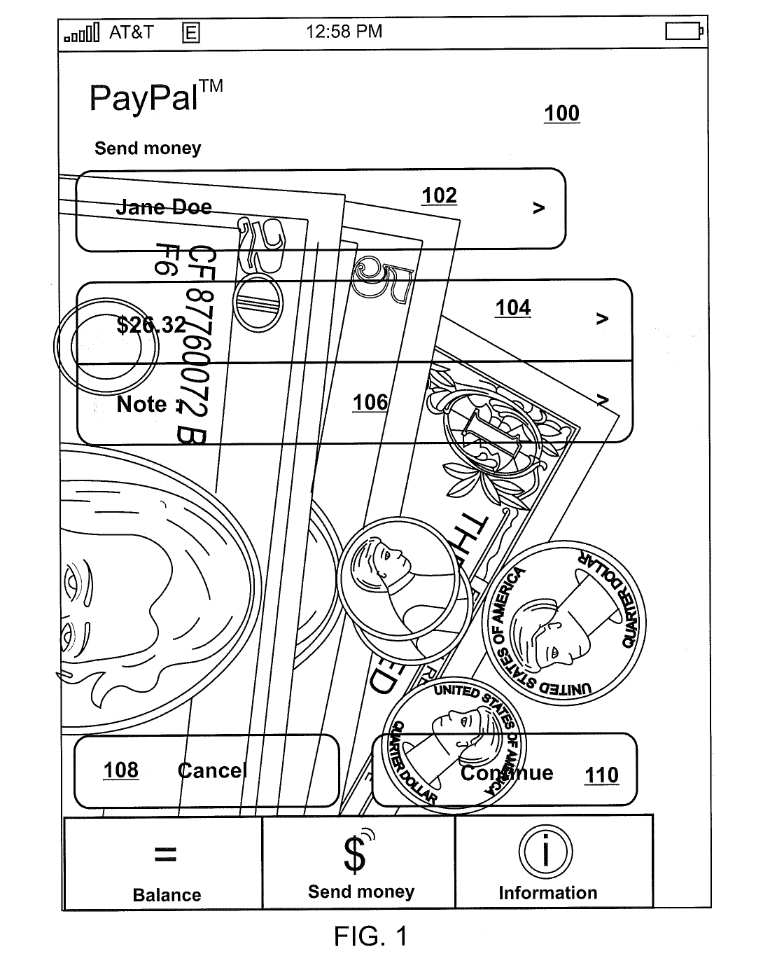

FIG. 1 shows a display 100 on a device illustrating one example of an embodiment of the present disclosure. The device can be any suitable device having a display, such as a mobile phone, laptop computer, PDA, or personal computer. In this embodiment, the device is a mobile phone. The example shows display 100 having a name box 102 indicating the recipient of funds, a funds box 104 indicating the amount of funds to be transferred, a note box 106 for the user to type in any notes to the recipient, a cancel button 108, and a continue button 110.

The user has entered $26.32 in funds box 104, such as by using the phone touchpad. Display 100 shows the actual currency representing this amount, namely one twenty dollar bill, one five dollar bill, one one dollar bill, one quarter, one nickel, and two pennies. Once the user is ready to send the shown amount, continue button 110 may be tapped, which either transfers the amount to the recipient shown in name box 102 or shows another screen prompting the user with more options. When the funds are transferred, display 100 may show the actual currency being moved off the screen, fading away, disappearing, or any other representative graphic. Note that transferring funds via a mobile phone is known, such as through PayPal in San Jose, Calif. Thus, details of how funds are transferred are not described herein.

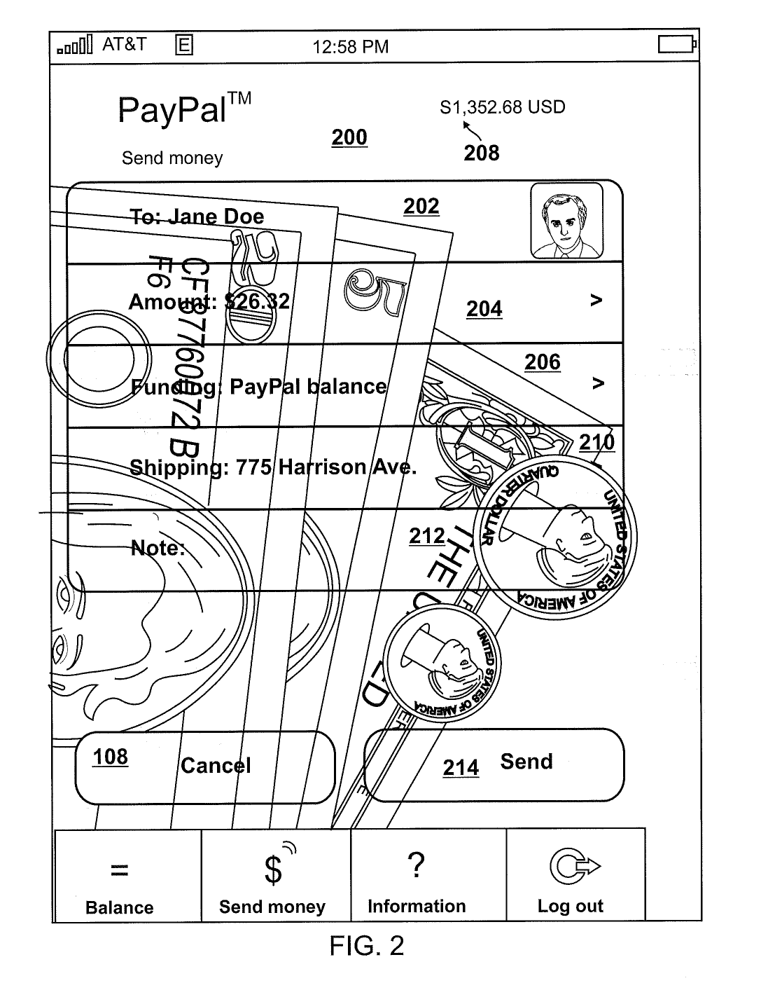

FIG. 2 shows a display 200 on a device illustrating another example of an embodiment of the present disclosure. The device can be the same as with FIG. 1. In this example, display 200 has a name box 202 indicating the recipient of funds as well as a picture of the recipient, a funds box 204 indicating the amount of funds to be transferred, a note box 212 for the user to type in any notes to the recipient, cancel button 108, and a send button 214 to transfer the funds in noted in box 204. Display 200 has additional information, such as a funding source box 206, indicating the source or account where the user's funds will be transferred from, a balance area 208, indicating the current balance of the funding account, and an address box 210, indicating the address of the recipient. So, display 200 differs from display 100 in the amount of information provided on the screen. However, as with display 100, the actual currency representation is still present in the background.

Once the user decides to send the funds as shown, the display can indicate this with some movement of the actual currency display. Sending can be the user tapping on an appropriate button on the display, such as “Send,” “Confirm,” or “Proceed.” In one embodiment, the currency display can simply disappear. In other embodiments, the current display can fade away or move off the display, such as a lateral movement to the right. Other types of representations of the funds being transferred may also be suitable, which may or may not include an audio indication.

The type of currency shown may be automatically determined or user-selected. In the former case, the user device may detect the location of the user and use the currency of that country. This detection may be determined through GPS or any other location-determining method. Automatic determination may also be pre-set within the user device, such as the country in which the mobile device is registered by the user. User-selection can be performed in any number of ways. Some include the user selecting, from the user device on a menu or drop down list, the available types of currency available, such as U.S. dollar, Europe (or European country) Euro, Mexican (or other country) Peso, Australian dollar, British pound, Japanese yen, Indian rupee, Russian ruble, and South Korean won.

In some embodiments, the user may also select non-legal currency, such as poker or casino chips or gold bars. For example, if $765.32 were designated to be shown as casino chips, the display might show one purple $500 chip, two black $100 chips, two green $25 chips, three red $5 chips, and some indication of 32 cents, such as a single chip having 32 cents on its face or 32 cents in actual coins. In another example, if $765.32 was entered and displayed as gold bars, the gold bars may have specific values on them, such as $500, $100, etc., and may be of different sizes in a combination to represent the entered amount.

In other embodiments, the user can create and use his own personalized currency. One example may be the user's image or any other selected image on U.S. currency (or any other country currency). The personalized currency may be created on the user device, such as with a suitable application, or through a download from a networked site, such as a photo-editing site. If created off device, the personalized currency may be retrieved from storage on the phone or a networked storage device.

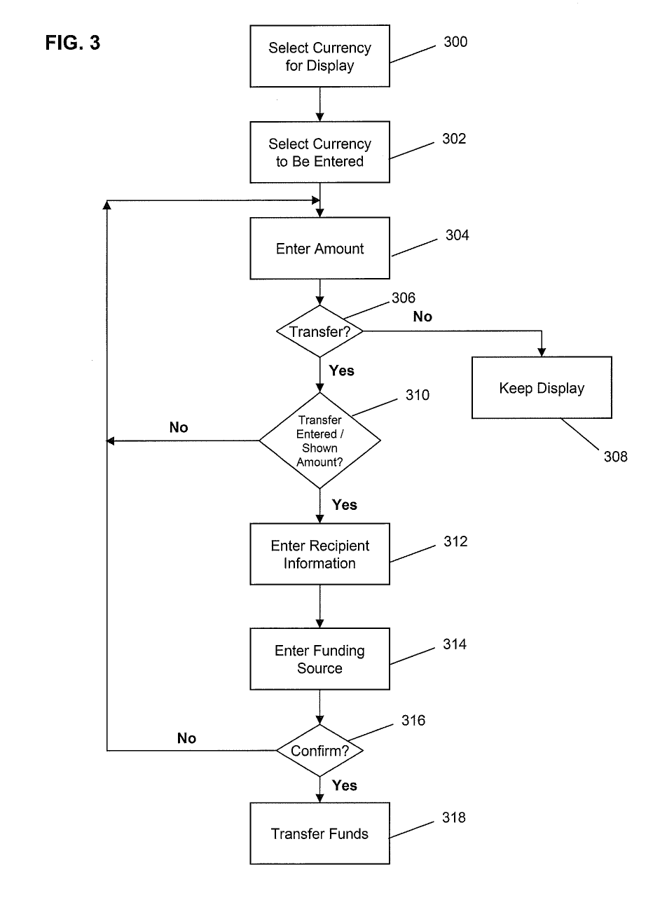

FIG. 3 shows a flowchart illustrating one embodiment of the present disclosure. In step 300, the user selects the desired currency for display, such as U.S. dollar, Mexican peso, British pound, European Euro, Japanese yen, South Korean won, etc. As discussed above, the selection can be manually selected by the user, such as from a menu or drop down screen, or determined from the user device, such as from the user's country of registration or user's funding source. For example, in the latter situation, if the user's funding source is in the United States, the device selects U.S. dollars as the currency. In some embodiments, even if the device determines the currency type, the user may have the option of overriding the selection and choosing a different currency.

Once selected, the user can select the type of currency, in step 302, that will be entered. For example, if the user wishes to see how $126.34 U.S. dollars in South Korean won looks like, the user would select South Korean won in step 300 and U.S. dollars in step 302. This capability may enable the user in a foreign land how much money he is willing to pay for something, such as in a bartering situation with local merchants, where the local merchant does not understand the user's language or native currency. In some embodiments, the device may default to the local currency or to the currency selected in step 300, where the user may have the option of overriding the default selection. With this capability, the device would have an application that converts currency, with at least a network connection accessing the latest currency conversion rates.

Once the currency display and entered amount are selected, the user enters an amount for display in step 304. The actual currency in the selected currency for that amount is then displayed. A simple application within the device or connected to the device generates the visual for the currency display. The actual layout and positioning for the different coins, bills, etc., may be pre-arranged, such as every time $126.34 is entered in U.S. dollars, the same display is shown. In other embodiments, the display may be different or random. Either way, the display preferably shows the user at least a portion of each currency amount so that it is clear from simply seeing the display how much money is shown. The user now has a visual of actual currency representing an entered money amount.

The user may then have different options for what to do with the display. For example, in one embodiment, the user may be prompted to decide if he wants to transfer the shown amount in step 306. As discussed earlier, the user may want to simply keep the display on screen to show a foreign merchant or other individual. If that is the case, the currency stays on the display, in step 308, for the user to show.

However, if the user wants to transfer money, the user may be prompted again to confirm whether the shown money is what is to be transferred in step 310. One reason the user may not want to transfer that money is a realization of how much money it actually is, which may be prompted from seeing the actual currency. It has been noted that when people handle or deal with simply money representations, such as casino chips, the sense of how much money is involved can sometimes be lost. Another reason the user may not want to transfer the shown amount is that the user may have mis-entered the amount in step 304, which is confirmed when seeing the actual currency displayed. For whatever reasons, if the user decides, after seeing he does not want to transfer that amount of money, the user may enter a new amount (in step 304) or simply quit the application.

If the user decides that he does want to transfer the indicated amount, the user enters information about the recipient in step 312 so that the funds can be transferred to the proper account or source. Information may include an e-mail address, mailing/shipping address, account number, etc. In one embodiment, the user may access and select from a list of recipients. Next, the user, in step 314, selects a funding source, such as PayPal, a bank, a credit card, a debit card, etc. If the user has only one funding source, this step is skipped. Once the funding source is selected, one embodiment may show the current balance in the funding source and any other information related to the source, such as past transactions. In some embodiments, the user may also be able to enter a note to the recipient, such as by typing in a note box on the device display, and send the note with the money transfer.

After seeing the funding source balance, the user may decide to cancel the transaction if the source does not have sufficient funds, switch the funding source to a different account, or transfer a lesser amount (step 304). However, if the user still wants to proceed with the transfer, the user confirms the transaction, such as by tapping an appropriate button, and the shown funds are transferred to the desired recipient in step 318.

Another way to transfer the funds is have the user simply slide the visual currency to a recipient icon on the display. In this embodiment, when the recipient is selected, an appropriate icon may appear on the screen, such as a picture of the person. The user may then slide or drag the funds over the icon, which would show the funds disappearing or entering the icon, to represent a successful transfer. In other embodiments, multiple icons may be on the screen so that the user can simply slide the funds to the desired user without entering recipient information, such as in step 312. Processes for transferring funds via a phone or over mobile device are known, such as through PayPal. Thus, details of the money transfer are not described herein.

Once the money is sent, the displayed currency disappears or is shown moving out of the device display. For example, the displayed currency may simply disappear, slowly fade away, move out of the display, such as to the right, explode, enter the recipient's icon, or any suitable graphic. In other embodiments, the displayed currency may simply stay there until the user changes it.

In other embodiments, the display on a device may show a financial instrument, such as a specific type of credit card, bank card, or debit card. These may or may not be the selected funding sources. Once selected or swiped, the display may show the specific card, such as a PayPal card, Visa, MC, AMEX, etc., as contrasted to a generic representation of a card or no visual at all. The visual image of the card could be shown in the background and relevant information, such as balance, past transactions, current transaction, amount, etc., can be shown on the foreground.

In one embodiment, the recipient device may have the same or similar currency display features as described herein for the user (or transferring) device. For example, when funds are received by the recipient, an animation or visual can be displayed on the recipient device, showing the actual currency sent from the sender's account, the currency of the recipient's country, or a recipient-designed or selected “currency” such as casino chips, gold bars, personalized bills and coins, or even items such as banana peels. Also, as with the sender side, the recipient can decide the source for the sent funds, such as the recipient's bank account, money market fund, or credit card. The recipient's device may show the actual currency fading into the display, suddenly appearing on the display, moving into the display and then into an icon representing a receiving source, or any other suitable graphic or animation.

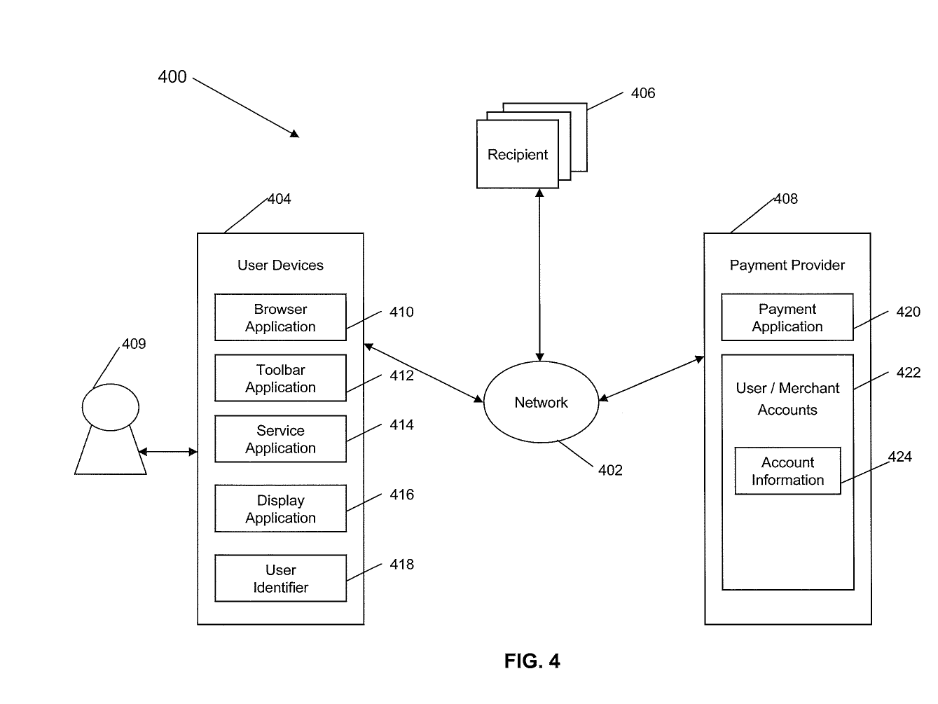

FIG. 4 is a block diagram showing one embodiment of a system 400 configured to utilize the currency display over a network 402. System 400 includes at least a user device 404, one or more recipient 406 devices, and at least one payment provider server 408 in communication over the network 402.

In one embodiment, the network 402 may be implemented as a single network or a combination of multiple networks. For example, in various embodiments, network 402 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

In one embodiment, user device 404 may be implemented using any appropriate combination of hardware and/or software configured for wired and/or wireless communication over network 402. For example, user device 404 may be implemented as a personal computer of a user 409 (e.g., a client or customer) in communication with network 402, such as the Internet. In other examples, user device 404 may be implemented as a wireless telephone (e.g., cell phone), personal digital assistant (PDA), notebook computer, and/or various other generally known types of computing devices.

In one embodiment, user device 404 may include one or more browser applications 410 which may be used, for example, to provide a user interface to permit user 409 to browse information available over network 402. For example, browser application 410 may be implemented as a web browser to view information available over the Internet. User device 404 may also include one or more toolbar applications 412, which may be used, for example, to provide client-side processing for performing tasks in response to operations selected by user 409. For example, toolbar application 412 may display a graphical user interface (GUI) in connection with browser application 410.

In one embodiment, user device 404 may include a service application 414 for facilitating financial transactions on network 402, including money transfer, which is discussed in greater detail herein. In one implementation, service application 414 comprises a software program, such as a graphical user interface (GUI), executable by a processor that is configured to interface and communicate with the one or more recipient devices 406 and payment provider server 408 via network 402. User 409 is able to transfer funds to recipients through recipient device 406 by communicating with payment provider server 408. User device 408 also includes a display application 416 that determines the proper currency display from the entered money amount and currency type. Display application may also facilitate the user creating his own currency type.

User device 408 may include one or more user identifiers 418, which may be implemented, for example, as operating system registry entries, cookies associated with browser application 410, identifiers associated with hardware of user device 404, or various other appropriate identifiers. User identifier 418 may include attributes related to the user, such as personal information (e.g., a user name, password, photograph image, biometric id, address, phone number, etc.) and banking information (e.g., banking institution, credit card issuer, user account numbers, security information, etc.). In various implementations, user identifier 418 may be passed with a user money transfer request to payment provider server 408, and user identifier 418 may be used by payment provider server 408 to associate user 409 with a particular user account maintained by payment provider server 408.

In one embodiment, recipient devices 406 may be the same or have the same basic features as user device 404. Accordingly, each recipient may be associated with one or more devices that can communicate with network 402 and which can receive payment information from user 409 and/or from payment provider server 408 over network 402. Recipient devices 406 may include attributes related to the recipient, such as personal and banking information, as well as icon information. As a result, user device 404 may be able to access recipient attributes, such as icon information, for display or use by user device 404. In various implementations, attributes may be passed with a money transfer from user 409 to payment provider server 408, and the attributes may be used by payment provider server 408 to associate a particular money transfer with a particular recipient account maintained by payment provider server 408. Each of the one or more recipients may need to establish an account with payment provider server 408 so that payment server provider 408 is able to process money transfers from user 409.

In one embodiment, payment provider server 408 may be maintained, for example, by an online payment service provider, which may provide payment processing for online transactions between user 409 and a recipient. In this regard, payment provider server 408 includes one or more payment applications 420, which may be configured to interact with user device 404 and/or each of recipient devices 406 over network 402 to facilitate the money transfer from user 409 to a recipient. In one example, payment provider server 406 may be provided by PayPal, Inc. of San Jose, Calif., USA.

In one embodiment, payment provider server 408 may be configured to maintain a plurality of user and recipient accounts 422, each of which may include account information 424 associated with individual users, including user 409, and the one or more recipient device 406. For example, account information 424 may include private financial information of user 409 and recipients, such as one or more account numbers, passwords, credit card information, banking information, or other types of financial information, which may be used to facilitate online transactions between user 409 of user device 404 and one or more recipients associated with recipient devices 406. As such, payment application 420 may be configured to interact with the one or more recipient devices 406 on behalf of user 409 during a transaction without requiring user 409 to provide account information 424 directly to recipient device 406.

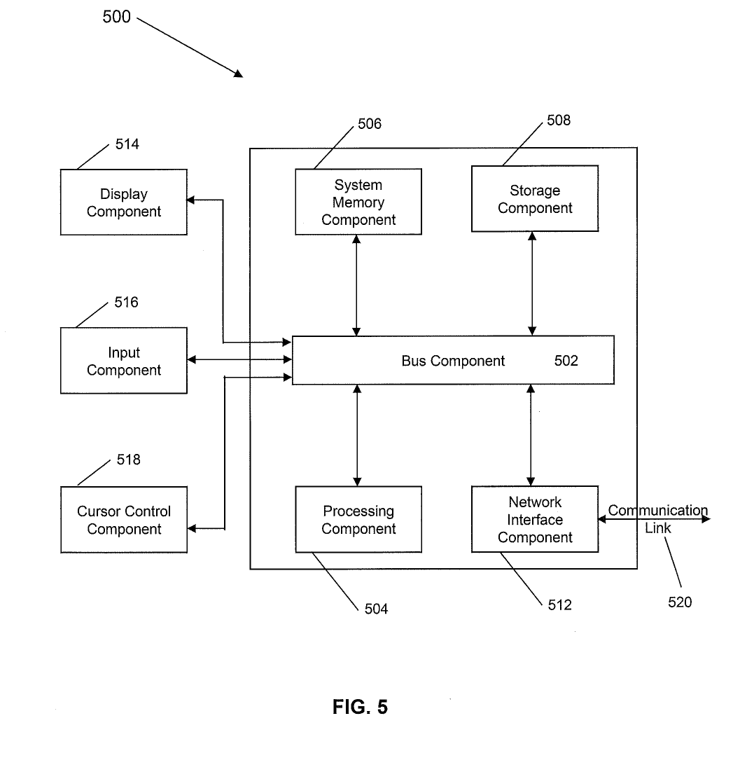

FIG. 5 is a block diagram of a system 500 suitable for implementing embodiments of the invention, including user device 404, one or more recipient devices 406, and payment processing device 408. System 500, such as part of a cell phone, personal computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a network interface component 512, a display component 514, an input component 516 (e.g., keypad or keyboard), and a cursor control component 518 (e.g., a mouse pad).

In accordance with embodiments of the invention, system 500 performs specific operations by processor 504 executing one or more sequences of one or more instructions contained in system memory component 506. Such instructions may be read into system memory component 506 from another computer readable medium, such as static storage component 508. These can include instructions to create and display the proper currencies, convert currency, display various types of graphics showing transfer of currency, etc. In other embodiments, hard-wired circuitry may be used in place of or in combination with software instructions to implement the invention.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different currency types and denominations. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the invention, execution of instruction sequences to practice the invention may be performed by system 500. In various other embodiments, a plurality of systems 500 coupled by communication link 520 (e.g., network 402 of FIG. 4, LAN, WLAN, PTSN, or various other wired or wireless networks) may perform instruction sequences to practice the invention in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. For example, steps shown in FIG. 3 or described in connection with FIG. 3 may be omitted, performed in different order, modified, or added, while still achieving advantages of the present disclosure. Furthermore, the visual representation of the currency may be static or dynamic, i.e., the visual can be an animation or a storyboard of an animation showing coins rolling or any other movement.

Having thus described embodiments of the invention, persons of ordinary skill in the art will recognize that changes may be made in form and detail without departing from the scope of the invention. Thus, the invention is limited only by the claims.

What is claimed is:

1. A device comprising:
an input device configured to allow a user to enter a money amount;
a processor configured to convert the money amount into a visual representation of a specific type of currency; and
a display showing the visual representation of the currency.

2. The device of claim 1, wherein the currency is selectable by the user.

3. The device of claim 1, wherein the currency is creatable by the user.

4. The device of claim 1, wherein the device is configured to transfer the money amount to a recipient.

5. The device of claim 4, wherein the display shows information about the recipient.

6. The device of claim 5, wherein the information is selected from a group comprising a name, an address, an e-mail, and an icon.

7. The device of claim 4, wherein the display shows a funding source for the money amount being transferred.

8. The device of claim 7, wherein the funding source is a debit card, a credit card, a bank card, a bank account, or a financial services account.

9. The device of claim 4, wherein the display shows a balance of a funding source for the money amount being transferred.

10. The device of claim 1, wherein currency for the entered money amount and the currency displayed are different.

11. The device of claim 1, wherein the display further shows the currency being transferred to a recipient.

12. The device of claim 4, wherein the transfer is effected through a tap or dragging the currency to an icon on the display.

13. The device of claim 1, wherein the device is a mobile phone.

14. A method of generating a display on a user device, the method comprising:
receiving a monetary amount;
converting the monetary amount to a visual display of a specific type of currency; and
displaying the currency.

15. The method of claim 14, further comprising displaying the monetary amount and the currency together.

16. The method of claim 14, further comprising transferring the monetary amount to a recipient through the user device.

17. The method of claim 16, wherein the transferring comprises a tap or a movement of the currency to a visual representation of the recipient on the device.

18. The method of claim 14, further comprising receiving an indication of a type of currency for the monetary amount.

19. The method of claim 14, further comprising receiving an indication of a type of currency for the currency displayed.

20. The method of claim 14, wherein the currency of the monetary amount is different than the currency displayed.

21. The method of claim 16, further comprising displaying information about the recipient.

22. The method of claim 21, wherein the information comprises a name, an e-mail, an address, an account number, or an icon.

23. The method of claim 16, further comprising displaying information about a funding source for the monetary amount.

24. The method of claim 23, wherein the information comprises a name, a balance, previous transactions, or an icon.

25. The method of claim 14, wherein the currency is a user-created or non-legal currency.

26. The method of claim 16, further comprising showing a visual representation when the monetary amount is transferred.

27. The method of claim 26, wherein the visual representation comprises moving the currency off the display, fading the currency from the display, or removing the currency from the display.

28. The method of claim 14, further comprising selecting a receiving source for the monetary amount.

29. The method of claim 28, wherein the receiving source is shown on the display.

30. The method of claim 28, wherein the receiving source comprises a recipient's bank account, credit card, or financial account.

31. A device comprising:
a processor configured to receive a money amount from a sender and convert the money amount into a visual representation of a specific type of currency; and
a display showing the visual representation of the currency.
